(19) United States
(12) Patent Application Publication
(10) Pub. No.: US 2025/0026478 A1
(43) Pub. Date: Jan. 23, 2025

(54) Child Airplane Lap Restraint Device

(71) Applicant: Jason Miller, Hamilton, NJ (US)

(72) Inventor: Jason Miller, Hamilton, NJ (US)

(21) Appl. No.: 18/760,325

(22) Filed: Jul. 1, 2024

Related U.S. Application Data
(60) Provisional application No. 63/514,600, filed on Jul. 20, 2023.

(51) Int. Cl. B64D 11/06; A47D 13/02

(52) U.S. Cl. CPC B64D 11/0612; A47D 13/025; B64D 11/062

(57) ABSTRACT

A child airplane lap restraint device for securing a child close to a parent or adult during air travel. The device includes a parent/adult portion that includes a comfortable, padded belt segment that wraps around the parent's abdomen, equipped with airplane seat-compatible buckles for secure fastening. A pair of cross shoulder straps extend from the belt for a snug fit around the parent/adult. A child portion includes a triangular front surface that provides crucial support to the child's back, with leg loops for extended leg comfort. A pair of child-supporting shoulder straps secure around the parent's shoulders. A pair of buckles connect the parent and child portions and are designed to absorb and distribute forces during sudden movements, thereby maintaining the child's position in the parent's lap.

### CROSS-REFERENCE TO RELATED APPLICATION

The present application claims priority to, and the benefit of, U.S. Provisional Application No. 63/514,600, which was filed on Jul. 20, 2023, and is incorporated herein by reference in its entirety.

### FIELD OF THE INVENTION

The present invention generally relates to the field of child carrying belt devices. More specifically, the present invention relates to a novel child airplane lap restraint device for children designed to help parents secure and comfort their children while flying on an airplane. The includes shoulder straps for securing around the parent and the child and includes airplane belt compatible buckle for securing the device when used for securing a child. A child sits in a child portion connected to a parent portion and the child can sit facing towards or away from the parent. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals travel a lot in airplanes for commuting across states and countries. However, airplane travelling with infants can be challenging for parents or guardians. Airplane seats are generally small and cramped and there is less space to accommodate both parent and their child which causes discomfort for both parent and child. Moreover, a parent or guardian continuously holds the child on the lap to ensure the safety of their child during the flight. This is not only laborious but does not enable a parent to have a break or relax during the flight. However, even when a child is being held, there is a risk of slipping away of the child from their parent or guardian's lap during turbulence or emergency landings. This poses a safety concern for the child. Many children may become anxious or upset during a flight when they cannot constantly sit in a parent's lap. As a result, children cry for long hours which causes discomfort for both the child and the individuals around them, causing a disturbance for other passengers.

It is also difficult for parents and guardians to carry infants and toddlers through long security lines, busy waiting areas, and more at airports. Individuals also find it difficult to scan a boarding pass and/or show documents such as VISA to officials while carrying a child in their arms. Individuals desire a secure harness restraint that keeps a child close to their parent or guardian and is designed specifically for use on airplanes to keep the child safe and happy.

Therefore, there exists a long felt need in the art for a device that securely holds a child close to a parent or guardian. Additionally, there is a long felt need in the art for a child carrying device that can be used securely in an airplane. Moreover, there is a long felt need in the art for a child airplane lap restraint device that keeps a child close to parent without requiring the parent to physically hold the child using hands. Further, there is a long felt need in the art for a child carrying belt device that enables a child to sit face towards or face away from a parent. Furthermore, there is a long felt need in the art for a specialized device to carry infants in the lap of a parent or guardian that can be secured to an airplane seatbelt to adhere to any restrictions in place by the airline, airplane, and/or flight crew. Finally, there is a long felt need in the art for a novel child carrying restraint device that includes multiple straps that go over the shoulders of the parent or adult and child and securable via buckles to keep the child firmly in place.

The subject matter disclosed and claimed herein, in one embodiment thereof, comprises a child airplane lap restraint device. The device comprising a parent portion and integrated child portion, the parent portion secures around a parent's abdomen and includes a circular loop-shaped padded belt segment with one or more airplane seat compatible buckles for fastening with an airplane seat belt. A pair of cross-fastened adjustable shoulder straps extend from the belt segment to secure around the shoulders of the parent or adult. The child portion has a front surface for providing body support, and a supporting belt disposed across the triangular front surface. A pair of child supporting shoulder straps extend from the top end opposite edges of the triangular front surface and fastened to the supporting belt, the child supporting shoulder straps being adapted to secure around the shoulders of a parent and across the child. A pair of buckles for integrating the parent portion and the child portion, the buckles providing resistance to forces during sudden movements to keep the child securely accommodated in the child portion close to the parent.

In this manner, the child airplane lap restraint device of the present invention accomplishes all of the forgoing objectives and provides users with a secure harness restraint which, when worn by a parent and child, helps keep the child secure and comfortable while traveling on an airplane. The device includes adjustable shoulder straps that go over the shoulders of the parent or adult and child, secured via buckles, to secure the child close to the parent. The device is secured to an airplane seat belt for providing additional security to both the parent and the child.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a child airplane lap restraint device. The device comprising a parent portion adapted to secure around a parent's abdomen, the parent portion has a circular loop-shaped padded belt segment with one or more airplane seat compatible buckles disposed on its outer surface for fastening with an airplane seat belt. A pair of cross-fastened adjustable shoulder straps extending from the belt segment to secure around the shoulders of the parent or adult. A child portion including a child accommodation seat with two leg loops formed by a child seat base, a substantially triangular front surface for providing body support, and a supporting belt disposed across the triangular front surface. A pair of child supporting shoulder straps extending from the top end opposite edges of the triangular front surface and fastened to the supporting belt, the child supporting shoulder straps being adapted to secure around the shoulders of a parent and across the child. A pair of buckles for integrating the parent portion and the child portion, the buckles providing resistance to forces during sudden movements to keep the child securely accommodated in the child portion close to the parent.

In another embodiment, the pair of buckles are designed to automatically fasten when subjected to jerks or sudden movements during airplane travel, thereby absorbing and distributing forces evenly across the child's body to reduce the impact of such movements.

In yet another embodiment, the supporting belt of the child portion includes a plurality of loops for adjusting its length, enabling for a customizable fit to accommodate children/toddlers of various sizes.

In another aspect of the present invention, a lap belt portion is secured to the adjustable shoulder straps, wherein the lap belt portion enhances the secure attachment of the parent or adult portion and the child portion via the pair of buckles, ensuring that the child remains safely and closely connected to the parent even in the event of sudden jolts or turbulence experienced during flight.

In yet another embodiment, a child restraint device for use on an airplane is disclosed. The device comprising a child portion adapted to seat a child facing a parent, the child portion includes a substantially triangular front surface providing support for the child's back and leg loops for accommodating the child's extended legs. A parent portion comprising a padded belt segment designed to encircle the abdomen of the parent or adult, a pair of adjustable shoulder straps extending from the belt segment and configured to wrap around the shoulders of the parent or adult, a pair of child-supporting shoulder straps extending from the child portion to wrap around the shoulders of the parent or adult and the shoulders of the child, buckles disposed on the belt segment for securing the device to an airplane seat, and a pair of integrating buckles facilitating the attachment of the parent or adult portion and the child portion, wherein the integrating buckles provide resistance to jerks and sudden movements during airplane travel to maintain the child or toddler securely in the parent's lap while enabling the parent's arms to remain free for case of movement.

In still another embodiment of the present invention, the child sits in the child portion facing away from the parent and the substantially triangular front surface provides support for the child's torso.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of a child airplane lap restraint device of the present invention in accordance with the disclosed architecture;

FIG. 2 illustrates a rear perspective view of the child airplane lap restraint device of the present invention in accordance with the disclosed architecture;

FIG. 3 illustrates an enlarged view of the buckles used for integrating the parent portion and the child portion of the child airplane lap restraint device of the present invention in accordance with the disclosed structure;

FIG. 4 illustrates a perspective view of a parent sitting on an airplane seat and securing a child using the child carrying restraint device of the present invention in accordance with the disclosed structure; and

FIG. 5 illustrates the child sitting and facing the parent and supported by the child airplane lap restraint device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a device that securely holds a child close to a parent or guardian. Additionally, there is a long felt need in the art for a child carrying device that can be used securely in an airplane. Moreover, there is a long felt need in the art for a child airplane lap restraint device that keeps a child close to parent without requiring the parent to physically hold the child using their hands. Further, there is a long felt need in the art for a child carrying belt device that enables a child to sit face towards or face away from a parent. Furthermore, there is a long felt need in the art for a specialized device to carry infants in the lap of a parent or guardian that can be secured to an airplane seatbelt to adhere to any restrictions in place by the flight. Finally, there is a long felt need in the art for a novel child carrying restraint device that includes multiple straps that go over the shoulders of the parent or adult and child, securable via buckles, to keep the child firmly in place.

The present invention, in one exemplary embodiment, is a child carrying belt device for use on an airplane. The device comprising a child portion adapted to seat a child facing a parent or facing away from the parent. The child portion includes a substantially triangular front surface providing support for the child's back and leg loops for accommodating the child's extended legs. A parent portion comprising a padded belt segment designed to encircle the abdomen of the parent or adult, a pair of adjustable shoulder straps extending from the belt segment and configured to wrap around the shoulders of the parent or adult, a pair of child-supporting shoulder straps extending from the child portion to wrap around the shoulders of the parent or adult and the shoulders of the child, buckles disposed on the belt segment for securing the device to an airplane seat, and a pair of integrating buckles facilitating the attachment of the parent or adult portion and the child portion, wherein the integrating buckles provide resistance to jerks and sudden movements during airplane travel to maintain the child securely in the parent's lap while enabling the parent's arms to remain free for case of movement.

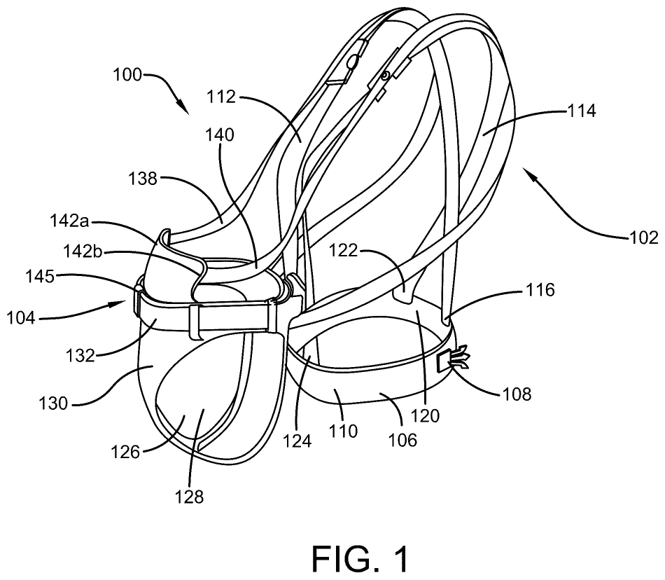

Referring initially to the drawings, FIG. 1 illustrates a front perspective view of child airplane lap restraint device of the present invention in accordance with the disclosed architecture. The child airplane lap restraint device 100 of the present invention is designed to secure a child close to a parent or guardian while flying on an airplane. The harness restraint device 100 includes a parent or adult portion 102 for securing around a parent and a child portion 104 for securing around a child sitting in lap of the parent or adult. The parent or adult portion 102 and the child portion 104 are connected to each other using buckles for enabling a child accommodated in the child portion 104 to be closer to the parent. More specifically, the parent or adult portion 102 includes a belt segment 106 designed to be worn around abdomen of the parent or adult. The belt segment 106 forms a circular loop, is padded and soft and can be adjusted in length around the abdomen of a parent. One or more airplane seat compatible buckles 108 are disposed on the outer surface 110 of the belt segment 106 for enabling the parent to fasten the buckle 108 with an airplane seat belt. The buckles 108 provide improved safety for both the parent and the child by securing the child carrying belt device 100 during turbulence or sudden jolts experienced during the flight.

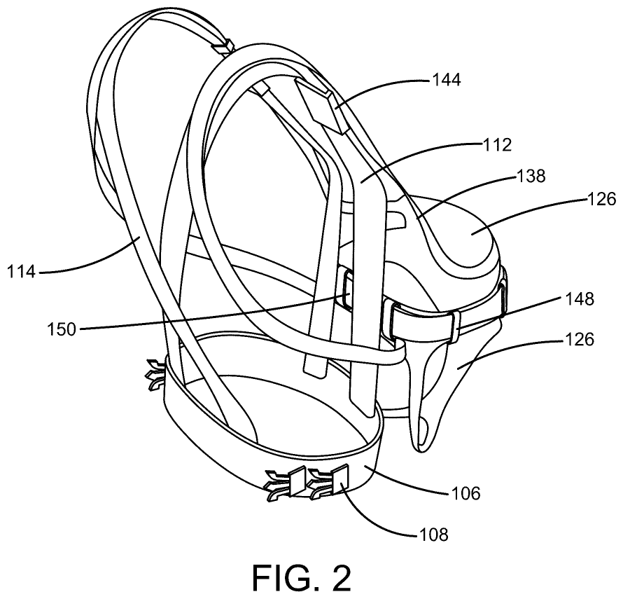

Referring to FIGS. 1 and 2, a pair of cross-fastened shoulder straps 112, 114 extend from the belt segment 106 for securing around the shoulders of the parent or adult. A first shoulder strap 112 extends between a first (rear) end 116 and a second (front) end 118 wherein the ends 116, 118 are diagonally opposite. The first end 116 is sewn to the inner surface 120 and the second end 118 is also sewn to the inner surface 120 of the belt 106. Similarly, the second shoulder strap 114 extends between a corresponding first (rear) end 122 and a corresponding second (front) end 124. The ends 122, 124 are diagonally opposed and sewn to the inner surface 120 of the belt segment 106. The shoulder straps 112, 114 are adjustable to fit users of different sizes. During use of the harness restraint device 100, the front ends 118, 124 are positioned on the torso of the parent or adult wearing the device 100 and the rear ends 116, 122 are positioned on the back of the parent or adult.

The child portion 104 includes a child accommodation seat 126 having two leg loops 128 formed by a child seat base 132. The leg loops 128 accommodate legs of a child in extended position. The child seat 126 has a substantially triangular front surface 130 for providing support to the body of a child sitting in the child portion 104. The child portion 104 includes a supporting belt 132 disposed across the triangular front surface 130. The supporting belt 132 forms a closed loop to wrap around the body of a child.

The child portion 104 also includes a pair of child supporting shoulder straps 138, 140 that goes around shoulders of a parent for providing support to the child. The child supporting shoulder straps 138, 140 extends from the top end opposite edges 142a, 142b of the triangular front surface 130 and fastened to the belt 132 to make loops to secure around shoulders of a parent. The straps 138, 140 can overlap a portion of the shoulder straps 112, 114 respectively for enabling a parent to easily wear the harness device 100.

Referring again to FIGS. 1 and 2, the shoulder straps 112, 114 are adjustable and each shoulder strap includes an adjustable member 144 for adjusting length of the strap. More specifically, the length of the straps 112, 114 can be separately and individually adjusted using corresponding adjustable member 144. The supporting belt 132 is adjustable using the adjustable buckle 146 and includes a plurality of loops 148 for adjusting the length of the supporting belt 132.

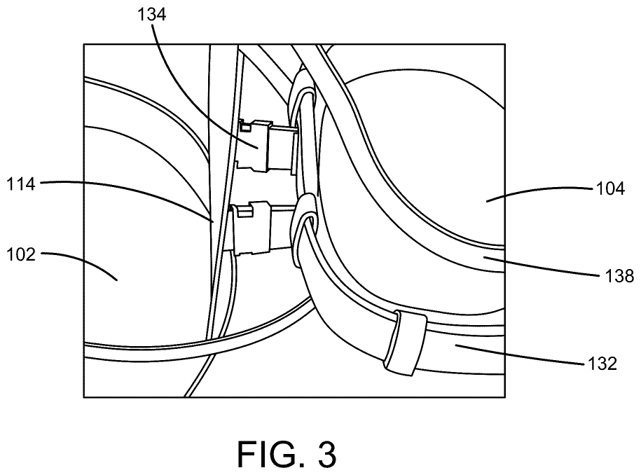

FIG. 3 illustrates an enlarged view of the buckles used for integrating the parent or adult portion 102 and the child portion 104 of the child airplane lap restraint device 100 of the present invention in accordance with the disclosed structure. The buckles 134, 136 are similar in structure, shape, and size and integrate the parent or adult portion 102 and the child portion 104. During a jerk, the buckles 134, 136 restrain the child portion 104 with the parent or adult portion 102. Referring to FIGS. 1 and 3, the parent or adult portion 102 and child portion 104 are integrated or can be detachably attached together using a pair of buckles 134, 136. Specifically, the buckle 134 fastens the shoulder strap 112 of the parent or adult portion 102 and the supporting belt 132 of the child portion 104. Similarly, the buckle 136 fastens the shoulder strap 114 of the parent or adult portion 102 and the supporting belt 132 of the child portion 104. A lap belt portion 150 is secured to the straps 112, 114 via which the buckles 134, 136 fasten the parent or adult portion 102 and the child portion 104. The buckles 134, 136 provide resistance to the force to the child accommodating in the child portion 104 when a jerk occurs during airplane travel. In the preferred embodiment, the buckles 134, 136 absorb and lessen the stress and jolts experienced by the child and distribute the force evenly across the child's body, reducing the impact of sudden movements. The buckles 134, 136 can automatically be fastened when a jerk is experienced during sudden movements.

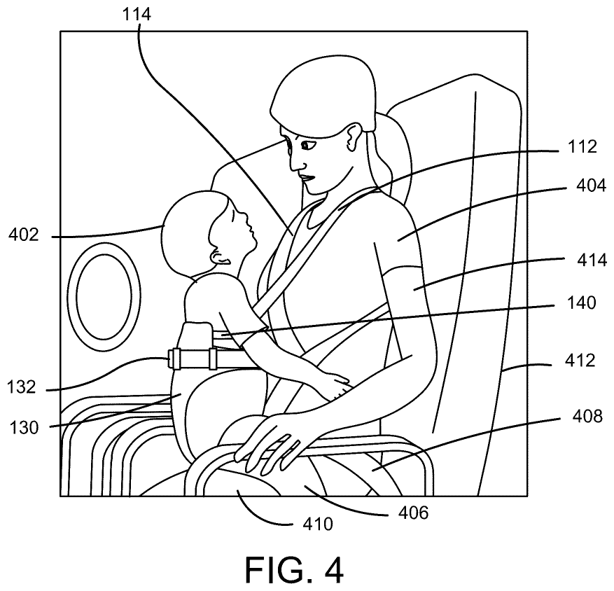

FIG. 4 illustrates a perspective view of a parent sitting on an airplane seat and securing a child using the child carrying restraint device 100 of the present invention in accordance with the disclosed structure. In the present embodiment, a child 402 sits in the child portion 104 facing a parent 404 wearing the device 100. The back 406 of the child 402 is supported by the front surface 130 and the legs of the child 402 are extended from the leg loops 128.

The shoulder straps 112, 114 and the straps 138, 140 are wrapped around the shoulders of the parent or adult 404 with the buckle 108 secured to the airplane seat buckle 408. The device 100 enables the child 402 to be securely placed in the lap 410 of the parent or adult 404 while the buckles 136, 138 enable absorption of the jerks during sudden movement of the airplane 412. It should be apparent to a person skilled in the art that arms 414 of the parent or adult 404 remain free while the device 100 is used for carrying the child 402. The straps 138, 140 can also be wrapped around the shoulders of the child 402 in some embodiments of the present invention.

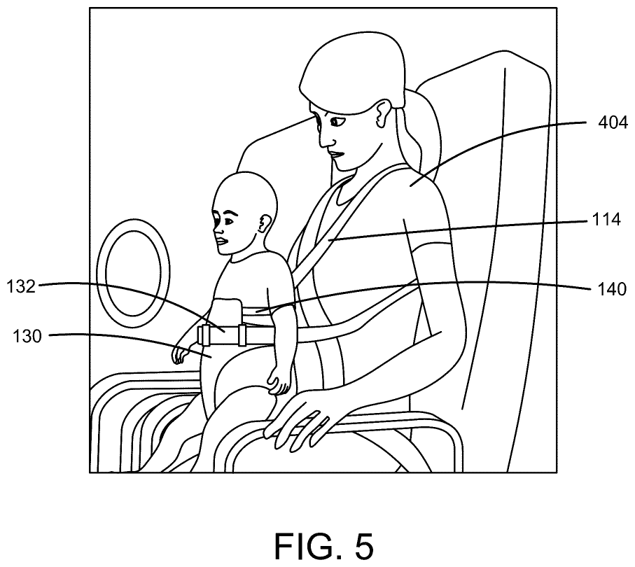

FIG. 5 illustrates the child 402 supported by the child airplane lap restraint device of the present invention in accordance with the disclosed structure. In the present embodiment, the child 402 sits in the child portion 104 while facing away from the parent 404. The straps 138, 140 are wraps around the chest or shoulders of the child 402 and then, secured around the shoulders of the parent or adult 404. The shoulder straps 112, 114 are wrapped around the shoulders of the parent or adult 404 while forming a cross-shape as illustrated in FIG. 2. The child 402 can sit comfortably without requiring the parent 404 to hold the child 402 continuously.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “child airplane lap restraint device”, “child carrying restraint device”, “harness restraint device”, “child carrying belt device”, and “device” are interchangeable and refer to the child airplane lap restraint device 100 of the present invention.

Notwithstanding the forgoing, the child airplane lap restraint device 100 of the present invention can be of any suitable size and configuration as is known in the art without affecting the overall concept of the invention, provided that it accomplishes the above stated objectives. One of ordinary skill in the art will appreciate that the child airplane lap restraint device 100 as shown in the FIGS. 1-3 are for illustrative purposes only, and that many other sizes and shapes of the child airplane lap restraint device 100 are well within the scope of the present disclosure. Although the dimensions of the child airplane lap restraint device 100 are important design parameters for user convenience, the child airplane lap restraint device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim

What is claimed is:

1. A child airplane lap restraint device comprising:
a harness restraint having an adult portion and a child portion, wherein said adult portion for securing around an adult and said child portion for securing around a child sitting in a lap of the adult;
wherein said adult portion and said child portion connected to each other with a first plurality of buckles for enabling the child to be secured adjacent to the adult;
wherein said adult portion having a belt segment for wearing around an abdomen of the adult; and
further wherein said adult portion having a second plurality of buckles disposed on an outer surface of said belt segment compatible with an airplane seat belt for securing said harness restraint with the airplane seat.

2. The child airplane restraint of claim 1, wherein said belt segment forming a loop adjustable in length around the abdomen of the adult.

3. The child airplane restraint of claim 2, wherein said adult portion having a pair of cross-fastened shoulder straps extending from said belt segment for securing around the shoulders of the adult.

4. The child airplane restraint of claim 3, wherein said pair of cross-fastened shoulder straps having a first shoulder strap extending diagonally between a rear side of said belt segment and a front side of said belt segment.

5. The child airplane restraint of claim 4, wherein said pair of cross-fastened shoulder straps having a second shoulder strap extending diagonally between said rear side of said belt segment and said front side of said belt segment.

6. The child airplane restraint of claim 5, wherein said first shoulder strap and said second shoulder strap are diagonally opposed.

7. The child airplane restraint of claim 6, wherein said rear side of said belt segment is proximal to a back of the adult.

8. The child airplane restraint of claim 7, wherein said front side of said belt segment is proximal to a front of a torso of the adult.

9. The child airplane restraint of claim 2, wherein said child portion having a seat including two leg loops formed by a child seat base and a front surface, further wherein said leg loops accommodate legs of a child in extended position.

10. The child airplane restraint of claim 9, wherein said front surface is triangular for providing support to the body of a child sitting in said child portion.

11. The child airplane restraint of claim 10, wherein said child portion having a support belt disposed across said front surface forming a closed loop around the body of the child.

12. The child airplane restraint of claim 11, wherein said child portion having a pair of shoulder straps for extending around the shoulders of the adult for providing support to the child.

13. The child airplane restraint of claim 12, wherein said pair of shoulder straps of said child portion extending from opposing edges of a top end of said front surface, around the shoulders of the adult, and back to said support belt.

14. A child airplane lap restraint device comprising:
a harness restraint having an adult portion and a child portion, wherein said adult portion for securing around an adult and said child portion for securing around a child sitting in a lap of the adult;
wherein said adult portion and said child portion connected to each other with a first plurality of buckles for enabling the child to be secured adjacent to the adult;
wherein said adult portion having a belt segment for wearing around an abdomen of the adult;
wherein said adult portion having a second plurality of buckles disposed on an outer surface of said belt segment compatible with an airplane seat belt for securing said harness restraint with the airplane seat;
wherein said adult portion having a pair of cross-fastened shoulder straps extending from said belt segment for securing around the shoulders of the adult; and
further wherein said child portion having a pair of shoulder straps for extending around the shoulders of the adult for providing support to the child.

15. The child airplane restraint of claim 14, wherein said belt segment forming a loop adjustable in length around the abdomen of the adult.

16. The child airplane restraint of claim 14, wherein said pair of cross-fastened shoulder straps having a first shoulder strap extending diagonally between a rear side of said belt segment and a front side of said belt segment.

17. The child airplane restraint of claim 16, wherein said pair of cross-fastened shoulder straps having a second shoulder strap extending diagonally between said rear side of said belt segment and said front side of said belt segment.

18. The child airplane restraint of claim 17, wherein said first shoulder strap and said second shoulder strap are diagonally opposed.

19. A child airplane lap restraint device comprising:
a harness restraint having an adult portion and a child portion, wherein said adult portion for securing around an adult and said child portion for securing around a child sitting in a lap of the adult;
wherein said adult portion and said child portion selectively attached to each other with a first plurality of buckles for enabling the child to be secured adjacent to the adult;
wherein said adult portion having a belt segment for wearing around an abdomen of the adult;
wherein said adult portion having a second plurality of buckles disposed on an outer surface of said belt segment compatible with an airplane seat belt for securing said harness restraint with the airplane seat;
wherein said adult portion having a pair of cross-fastened shoulder straps extending from said belt segment for securing around the shoulders of the adult;
wherein said child portion having a pair of shoulder straps for extending around the shoulders of the adult for providing support to the child; and
further wherein said child portion having a support belt disposed across a front surface of said child portion forming a closed loop around the body of the child.

20. The child airplane restraint of claim 19, wherein said pair of shoulder straps of said child portion extending from opposing edges of a top end of said front surface, around the shoulders of the adult, and back to said support belt.
